(19) United States
(12) Patent Application Publication
(10) Pub. No.: US 2013/0092307 A1
(43) Pub. Date: Apr. 18, 2013

(54) CONNECTION UNIT FOR CARBON FIBER RIM

(71) Applicant: KEE PING THO, JIANGSU (CN)

(72) Inventor: KEE PING THO, JIANGSU (CN)

(73) Assignee: KUNSHAN HENRY METAL TECHNOLOGY CO., LTD., JIANGSU (CN)

(21) Appl. No.: 13/271,593

(22) Filed: Oct. 12, 2011

(51) Int. Cl. B60C 5/00

(52) U.S. Cl. 152/450

(57) ABSTRACT

A carbon fiber rim assembly includes a carbon fiber rim having a bridge and two sidewalls extend respectively from two sides of the bridge. Each sidewall has a hook portion and an annular groove is defined between the bridge and the two sidewalls. A tire has a tread body and two lips extend respectively from two sides of the tread body. The lips are engaged with the hook portions. A reinforcement member is a plate and the hardness of the reinforcement member is higher than that of the tire. A connection unit includes a first connection member located at outsides of the sidewalls and a second connection member connected to the reinforcement member. The first and second connection members are connected to each other to position the reinforcement member between the sidewalls and the lips. The reinforcement member is easily installed and replaced.

### FIELD OF THE INVENTION

The present invention relates to a carbon fiber rim, and more particularly, to a connection unit for a carbon fiber rim for connect installation of a reinforcement member of the rim.

### BACKGROUND OF THE INVENTION

The rim is used for being connected with a tire and a hub is located at the center of the rim so as to be connected with the bicycle frame. By the rotation of the tire, the bicycle moves. The conventional rim is generally made by metal which is heavy so that the carbon fiber rim is developed which is light and strong.

The conventional rim includes a bridge with two sidewalls extending from two sides of the bridge. An annular groove is defined between the bridge and the two sidewalls. Each of the two sidewalls has a hooking portion. The tire is engaged with the annular groove and the two hooking portions are engaged with the lips of the tire. The conventional carbon finer rim is completely or partially made by carbon fiber. The partial carbon fiber rim includes aluminum alloy or other metal as the base and the carbon fiber is mounted to the base.

The conventional carbon finer rim, either the whole carbon fiber rim or the partial carbon fiber rim, the carbon fiber is located at the outside of the rim and the carbon fiber is hard, fragile and has less extendible character so that the conventional rim tends to get cracks so that the life of use is short. Once the conventional carbon finer rim is broken, the rim cannot be fixed and the tire cannot be well positioned. Therefore, reinforcement members are developed to increase the strength of the conventional carbon finer rims

The conventional reinforcement member usually located either at the area between the annular groove and the sidewalls, or at the sidewalls.

Taiwan Utility Model No. 096212178 discloses notches defined in outside of the sidewalls and so that the inside of the tire is engaged with the notches. Each of the two ends of the notches has an inward lip portion so as to securely engage with the tire. A reinforcement inner lining is engaged with the notches and matched with the inside of the notches. The two ends of the reinforcement lining are engaged with the lip portions.

Taiwan Utility Model No. 099206745 discloses a carbon fiber rim and a base ring is mounted to the hub. Two hooks are located on the base ring. A space is defined between the two hooks and a reinforcement member is located in the space and close to the hook to reinforce the hub.

However, because there are steel wires located in the lips of the tire and the steel wires are hard which generates friction between the lips and the reinforcement member and even break the reinforcement member when replacing the tire. In some circumstances, the carbon fibers of the rim are broken and the rim becomes weak and cannot bear stress. Furthermore, the reinforcement member is positioned at the annular groove or the sidewalls when manufacturing the rim and wrapped by the carbon fibers. The structure is complicated and the manufacturing cost is high. Once the reinforcement member is broken, it cannot be replaced.

The present invention intends to provide a connection unit for a carbon fiber rim so as to improve the shortcomings of the conventional connection unit.

### SUMMARY OF THE INVENTION

The present invention relates to a carbon fiber rim assembly and comprises a carbon fiber rim having a bridge and two sidewalls extend respectively from two sides of the bridge. Each sidewall has a hook portion and an annular groove is defined between the bridge and the two sidewalls. A tire has a tread body and two lips extend respectively from two sides of the tread body. The lips are engaged with the hook portions. A reinforcement member is a plate and the hardness of the reinforcement member is higher than that of the tire. A connection unit includes a first connection member located at outsides of the sidewalls and a second connection member connected to the reinforcement member. The first and second connection members are connected to each other to position the reinforcement member between the sidewalls and the lips. The reinforcement member is easily installed and replaced.

The primary object of the present invention is to provide a connection unit for a carbon fiber rim wherein the reinforcement member is positioned between the rim and the tire, and the connection unit is located between the reinforcement member and the rim. The connection unit includes a first connection member and a second connection member, both of which are hook-and-loop strips which easily position the reinforcement member.

Another object of the present invention is to provide a connection unit for a carbon fiber rim wherein the reinforcement member can be one-piece or multiple pieces, cooperated with the connection unit, the reinforcement member is individually replaced when needed.

Yet another object of the present invention is to provide a connection unit for a carbon fiber rim wherein the reinforcement member is made of a material whose hardness is higher than that of the tire, the material can be plastic, aluminum alloy or stainless steel.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a section of the carbon fiber rim and the reinforcement member positioned by the connection unit of the present invention;

FIG. 2 is a cross sectional view of the combination disclosed in FIG. 1;

FIG. 3 is an enlarged cross sectional view of the carbon fiber rim and the reinforcement member positioned by the connection unit of the present invention;

FIG. 4 a cross sectional view to show part of the carbon fiber rim, the tire, the reinforcement member and the connection unit of the present invention;

FIG. 5 an exploded view to show the carbon fiber rim, the tire, the reinforcement member and the connection unit of the present invention;

FIG. 6 is a cross sectional view of the second embodiment of the combination of the carbon fiber rim, the tire, the reinforcement member and the connection unit of the present invention, and

FIG. 7 is a side cross sectional view of the second embodiment of the present invention.

### DETAILED DESCRIPTION OF THE PREFERRED EMBODIMENT

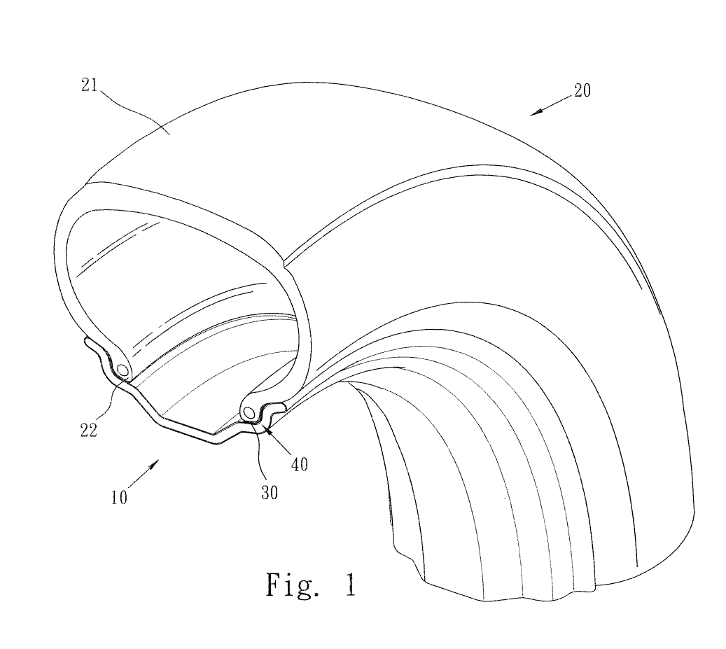

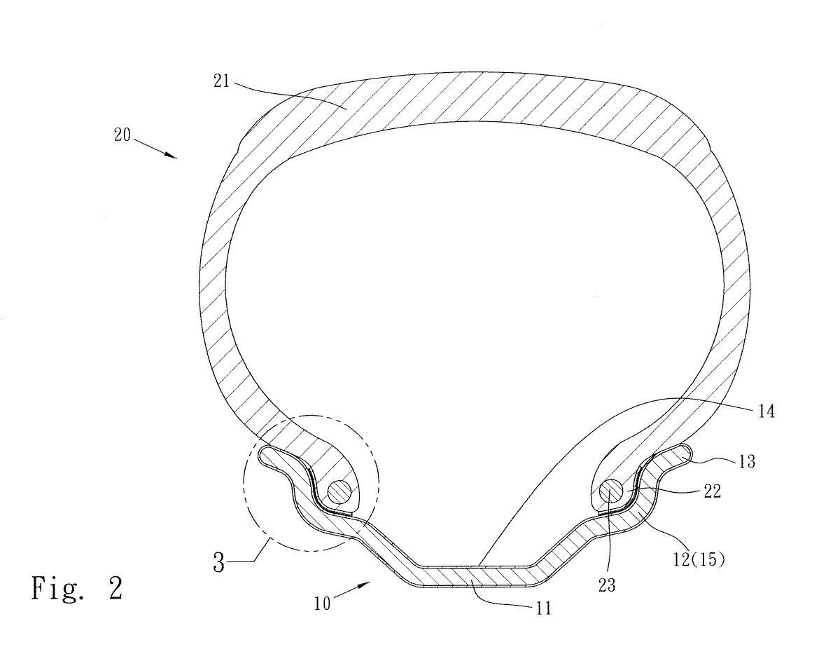

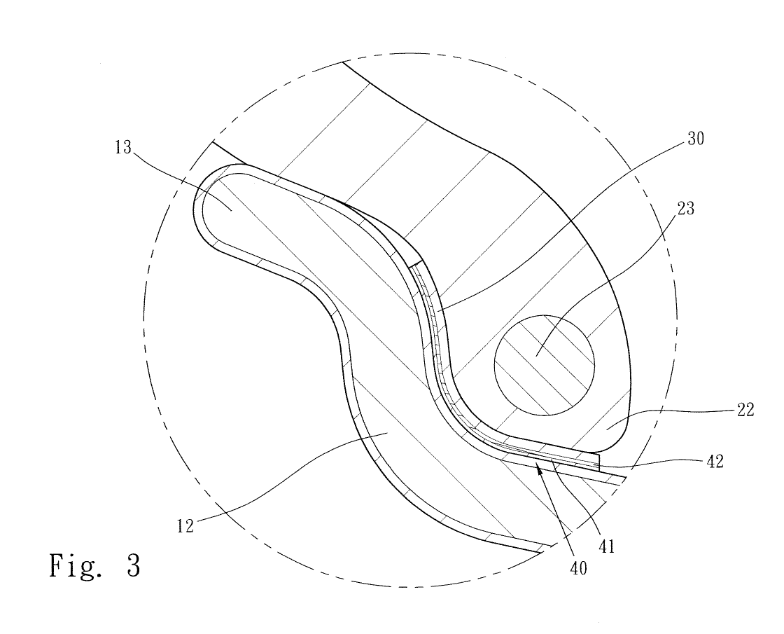

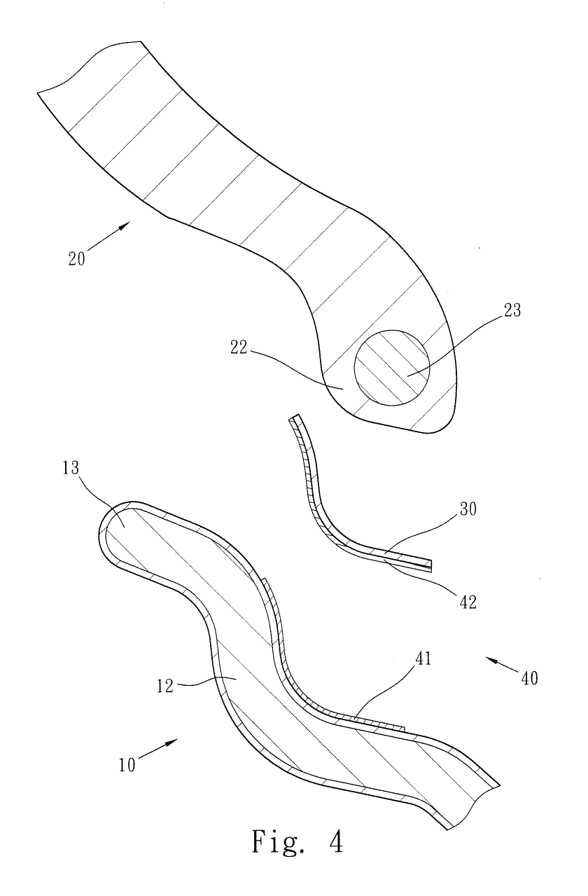

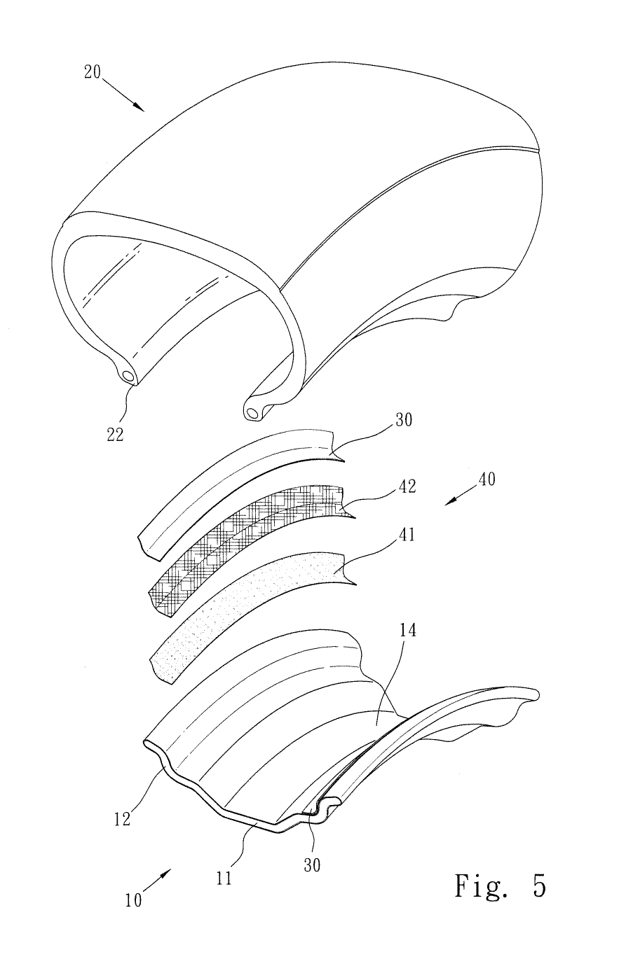

Referring to FIGS. 1 to 5, the carbon fiber rim assembly of the present invention comprises a carbon fiber rim 10, a tire 20, a reinforcement member 30 located between the carbon fiber rim 10 and the tire 20, and a connection unit 40 located between the carbon fiber rim 10 and the reinforcement member 30.

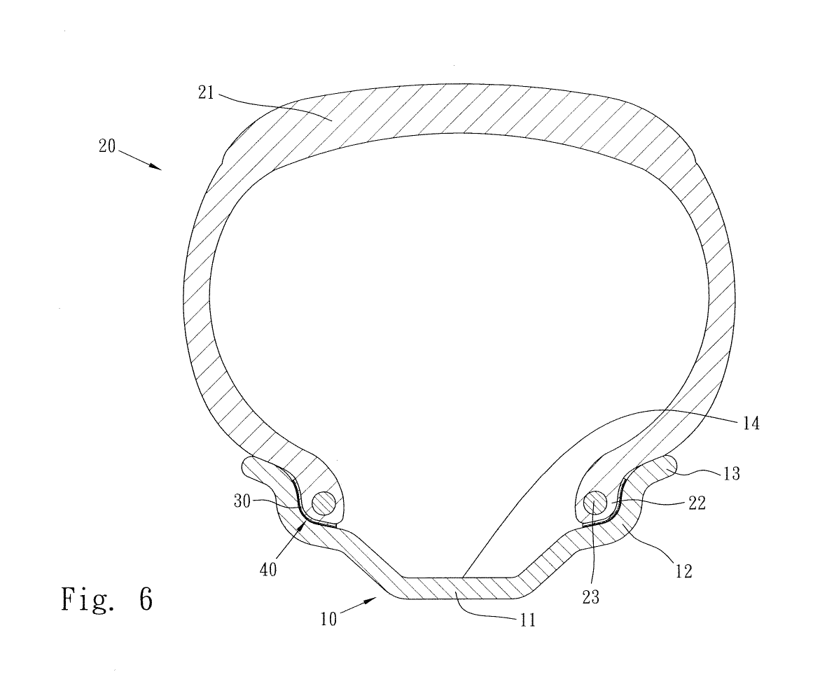

The carbon fiber rim 10 is a closed ring-shaped member and a bridge 11 is located on the outer periphery of the rim 10. Two sidewalls 12 extend respectively from two sides of the bridge 11 and each sidewall 12 has a hook portion 13. An annular groove 14 is defined between the bridge 11 and the two sidewalls 12. In this embodiment, the carbon fiber rim 10 comprises a base 15 which is made by alloy and carbon fibers 16 are mounted to outside of the base 15. As shown in FIG. 6 which is the second embodiment of the present invention, the carbon fiber rim 10 can be integrally formed of carbon fibers.

The tire 20 has a tread body 21 and two lips 22 extend respectively from two sides of the tread body 21. Steel wires 22 are located in the lips 22. The lips 22 are engaged with the hook portions 13 so as to connect the tire 20 to the annular groove 14 of the carbon fiber rim 10.

The reinforcement member 30 is a plate with a pre-set thickness and the hardness of the reinforcement member 30 is higher than that of the tire 20. The reinforcement member 30 is made by the material which can be plastic, aluminum alloy or stainless steel.

The connection unit 40 comprises a first connection member 41 and a second connection member 42, wherein the first connection member 41 is located at outsides of the sidewalls 12 and the second connection member 42 is connected to one side of the reinforcement member 30. The first and second connection members 41, 42 are two hook-and-loop strips. The first and second connection members 41, 42 are connected to each other so as to position the reinforcement member 30 between the sidewalls 12 and the lips 22.

When assembling, the first connection member 41 is located at the outsides of the sidewalls 12 and the second connection member 42 is then connected to one side of the reinforcement member 30. The first and second connection members 41, 42 are connected to each other to position the reinforcement member 30 between the sidewalls 12 and the lips 22.

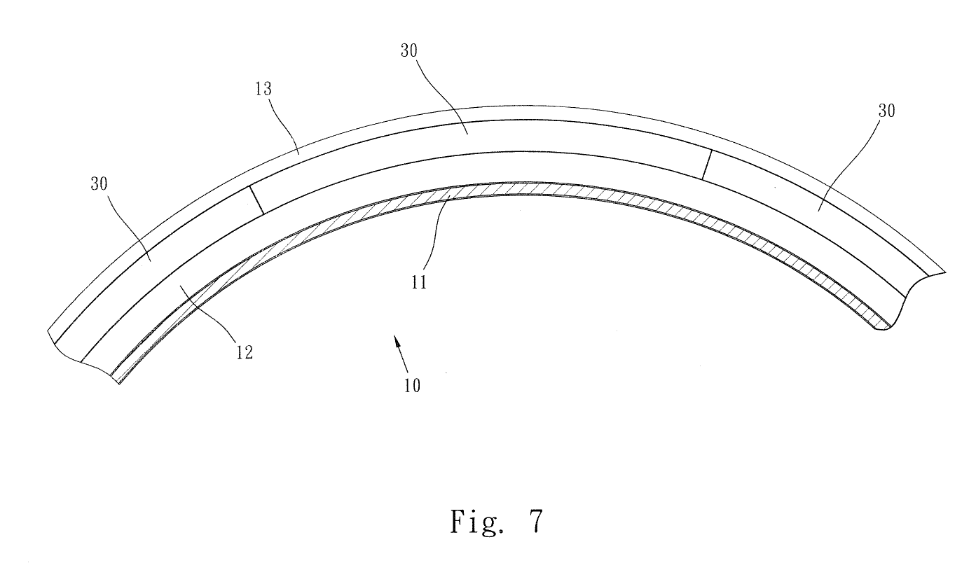

As shown in FIG. 7, which shows the third embodiment of the present invention wherein the sidewalls 12 have multiple consecutive reinforcement members 30 and a connection unit 40 is located between the reinforcement members 30 and the sidewalls 12. By the connection of the first and second connection members 41, 42, the reinforcement members 30 are spaced and positioned. Any of the reinforcement members 30 can be replaced individually.

The first connection member 41 and the second connection member 42 of the connection unit 40 are two hook-and-loop strips which can easily position the reinforcement members 30 so that the carbon-fiber rim 10 of the present invention is reinforced. The reinforcement member 30 can be one-piece or multiple pieces, cooperated with the connection unit 40, the reinforcement member 30 can be individually replaced when needed.

The reinforcement member 30 is made by plastic, aluminum alloy or stainless steel or other material that is harder than the tire 20 so as to have longer life.

The present invention provides the connection unit 40 for positioning the reinforcement member 30 and the connection unit 40 comprises the first connection member 41 and the second connection member 42, which can be two hook-and-loop strips which can easily position the reinforcement members 30 so that the carbon-fiber rim 10 of the present invention is reinforced.

While we have shown and described the embodiment in accordance with the present invention, it should be clear to those skilled in the art that further embodiments may be made without departing from the scope of the present invention.

What is claimed is:

1. A carbon fiber rim assembly comprising:
a carbon fiber rim having a bridge located on an outer periphery thereof and two sidewalls extending respectively from two sides of the bridge, each sidewall having a hook portion, an annular groove defined between the bridge and the two sidewalls;
a tire having a tread body and two lips extending respectively from two sides of the tread body, the lips engaged with the hook portions;
a reinforcement member being a plate and a hardness of the reinforcement member being higher than that of the tire, and
a connection unit having a first connection member and a second connection member, the first connection member located at outsides of the sidewalls and the second connection member connected to a side of the reinforcement member, the first and second connection members connected to each other so as to position the reinforcement member between the sidewalls and the lips.

2. The carbon fiber rim assembly as claimed in claim 1, wherein the carbon fiber rim comprises a base which is made by alloy and carbon fibers are mounted to outside of the base.

3. The carbon fiber rim assembly as claimed in claim 1, wherein the carbon fiber rim is integrally formed of carbon fibers.

4. The carbon fiber rim assembly as claimed in claim 1, wherein the reinforcement member is made of a material whose hardness is higher than that of the tire, the material is plastic, aluminum alloy or stainless steel.

5. The carbon fiber rim assembly as claimed in claim 1, wherein the first and second connection members are two hook-and-loop strips.
